(19) United States
(12) Patent Application Publication
(10) Pub. No.: US 2010/0228618 A1
(43) Pub. Date: Sep. 9, 2010

(54) CLOSED-SELLER ONLINE MARKETPLACE FOR LISTING EMPLOYEE-OWNED ASSETS WITH EMPLOYER-FUNDED SALES INCENTIVES

(76) Inventors: Chance E. Mitchell, Washington, DC (US); Justin G. Nelson, Washington, DC (US)

Correspondence Address: PCT LAW GROUP, PLLC, 818 CONNECTICUT AVENUE, NW, SUITE 700, WASHINGTON, DC, 20006, US

(21) Appl. No.: 12/397,099

(22) Filed: Mar. 3, 2009

(51) Int. Cl. G06Q 30/00; G06Q 50/00; G06F 17/30; G06F 7/08

(52) U.S. Cl. 705/14.39; 705/26; 705/14.73

(57) ABSTRACT

Systems, methods and computer program products for implementing and operating a closed-seller online marketplace for listing employee-owned assets with employer-funded sales incentives are disclosed. In an aspect, an employer who frequently relocates employees minimizes the costs associated with such relocation—employee's moving expenses, expenses related to the employee's current home until it is sold, and the cost of temporary housing for the employee in the new location. Such savings is achieved through an online marketplace where the employer can offer incentives for buyers to purchase real estate or other assets being sold by the (soon-to-be or already) relocated employee.

### FIELD OF THE INVENTION

The present invention generally relates to the provisioning of online marketplaces, and more particularly to systems, methods and computer program products for the use of such online marketplaces for facilitating employee relocation-related activities.

### BACKGROUND OF THE INVENTION

Many companies regularly relocate employees in response to the changing business needs. Uprooting an employee can be a costly endeavor, however, particularly when the employee owns a home. The sooner the employee has to start a new position in a new city, the more expensive it can be to relocate them. That is, if the employee is needed in the new location immediately, the employer will need to pay the employee's moving expenses, expenses related to the employee's current home until it is sold, and the cost of temporary housing for the employee in the new location. The employer will continue incur all of these expenses until the employee's current home is sold and they purchase a new one. Despite these expenses, employers are still willing to pay to relocate employees because of the growing need for skilled and proven executives combined with the high costs of recruiting and retaining employees in a competitive job market.

When there is a slowdown in the housing market, the cost of relocating an employee who owns a home skyrockets. Even during housing booms, the appreciation of a home that hasn't been held for many years is eaten up by the taxes, fees, and commissions that are paid when a home is sold. When an employee's home has not increased in value, or has dropped in value, employees become increasingly reluctant to sell their homes in order to relocate. Some companies have instituted “loss-on-sale” programs to reimburse employees for the expense of selling a home during a housing slump.

In order to overcome employees' hesitancy to relocate, companies offer increasingly generous relocation packages. However, even though many employers think the costs of relocating employees are outweighed by the benefits of having talented employees where they are most needed, there is still a push to keep relocation costs as low as possible. Some employers maintain a list of approved real estate agents that the employees must use in order to be reimbursed for certain expenses. Other employers place restrictions on a property's list price.

The above-described competing factors all help to explain why the executive relocation industry has, and continues to, flourish. However, while executive relocation professionals may be able to leverage their expertise to lower relocation costs, in some cases by selling an employee's home in less time than it might have taken the employee by themselves, savings to employers have been minimal.

In view of the high cost of relocating employees using existing employee relocation strategies, more beneficial and cost-effective systems and methods are needed to allow an employer to facilitate the sale of employees' homes in less time and reduce the cost of relocating employees.

### BRIEF DESCRIPTION OF THE INVENTION

The present invention meets the above-identified needs by providing systems, methods and computer program products for implementing and operating a closed-seller online marketplace for listing employee-owned assets with employer-funded sales incentives.

In one aspect, a method and computer program product for operating an online marketplace for listing employee-owned assets with employer-funded sales incentives, is provided. The method and computer program product include the steps of providing a user interface to an employer and its employees, receiving a request to include a property listing in the online marketplace's database from one of the employees, and getting permission from the employer to list the property on the online marketplace. Once permission is received, the property listing is stored in a database and the employer has the option of associating a sales incentive with the listing, whereby the incentive in some way would affect a buyer's cost associated with entering into a sale transaction involving the property. The method and computer program product further include the steps of allowing prospective buyers to access to a search engine capable of searching the database; and the user interface displaying search results which include the property listing and reflecting the sales incentive.

In another aspect, a system for operating an online marketplace for listing employee-owned assets with employer-funded sales incentives is provided. The system includes a user interface capable of being accessed over a computer network (e.g., the Internet, an internet or an intranet) by an employer and its employees, and a database for storing property listings, wherein the properties belong to the employees and optional incentives specified by the employer for each listing. In such an aspect, the sales incentives would affect the cost of a sale transaction involving the properties in the listing. The system further includes a search engine having access to, and capable of searching, the database and a calculator for recalculating one or more of the incentives over time based on certain criteria. The user interface of the system is further capable of displaying property listing search results reflecting the (static or dynamically-adjusted) incentives in response to queries of the database.

Further features and advantages of the present invention, as well as the structure and operation of various aspects of the present invention, are described in detail below with reference to the accompanying drawings.

### BRIEF DESCRIPTION OF THE DRAWINGS

Various aspects and other aspects of this invention will be readily apparent from the detailed description below and the appended drawings, which are meant to illustrate and not to limit the invention, and in which:

FIG. 1 is a block diagram of an exemplary online marketplace system according to various aspects of the invention;

FIG. 2 is a flowchart illustrating an exemplary operational overview process according to various aspects of the invention;

FIG. 3 is a flowchart illustrating an exemplary employer operational process according to various aspects of the invention;

FIG. 4 is a flowchart illustrating an exemplary employee operational process according to various aspects of the invention;

FIG. 5 is a flowchart illustrating an exemplary prospective purchaser operational process according to various aspects of the invention; and

FIG. 6 is a block diagram of an exemplary computer system useful for implementing the present invention.

### DETAILED DESCRIPTION OF THE INVENTION

Various aspects of the present invention create a new and improved way to offer real estate or other assets for sale through a closed-seller online marketplace. Various aspects cover systems, methods and computer program products for implementing a closed-seller online marketplace which only includes listings for employer-approved assets. Various aspects cover combining employer-funded sales incentives with non-employer-funded sales incentives, advertiser promotions and discounts, and service provider promotions and discounts into an incentive package.

Although many of the aspects discussed herein refer to real property, aspects may also apply to other types of property which an employer may have an interest in assisting an employee to sell, including, for example and without limitation, boats, furniture or vehicles. In addition, although many of the aspects discussed herein refer to sales assistance, aspects may also apply to other types of transactions, including, for example and without limitation, finding tenants to sublet rented property or assigning other contractual obligations which can no longer easily be met from the relocation destination. Furthermore, although many of the aspects discussed herein refer to employees who are being relocated by their employers, aspects may also apply to companies who are relocating individuals in anticipation of their employment, after an individual has ceased working for the employer as part of a retirement package, or as part of an agreement made as a relocation incentive. Although many of the aspects discussed herein refer to an employee who is being relocated, aspects may also apply to employees who are not being relocated, but have been given approval by their employers to post property listings.

It can be appreciated by those skilled in the relevant art(s) that aspects of the systems and methods described herein provide many benefits. Various aspects allow employers to expedite the employee relocation process by aggregating homes which are being sold by employees who are being relocated into a closed-seller online marketplace. Various aspects also allow employers to efficiently manage the sales incentives they are offering by allowing employers to search, view, and run reports on various aspects of their employees' property listings in the closed-seller online marketplace.

In one aspect, the closed-seller online marketplace limits eligible property listings to employer-approved property listings. The seller limitation will appeal to prospective purchasers for several reasons. The seller limitation will provide prospective purchasers with information about the current owners. All of the homeowners will be stable, responsible employees who have done well enough in their jobs that their employers are willing to pay to let them post a property listing. This type of person may be perceived to be more likely to have taken proper care of the home. In addition, prospective purchasers will know that many of the property listings will have employer-funded sales incentives, so the prospective purchaser will be more likely to find a bargain.

These benefits may draw more traffic to the closed-seller online marketplace from prospective purchasers. The increased traffic can lower the cost of relocating employees and decrease the time it takes for employees to liquidate selected assets prior to relocation.

In various aspects, an employer approves each property listing to be posted on the closed-seller online marketplace along with employer-funded sales incentives, if any, to be included in the property listing (i.e., information describing the asset). A property listing may include information in a variety of formats including, but not limited to, text, pictures, audio, video and/or links to any type of web site with information of interest to a prospective purchaser of the property. It may be posted by an employee who is, for example and without limitation, relocating within the United States, relocating into the United States, or relocating out of the United States.

An employer may approve numerous property listings for employee-owned assets and manage the employer-funded sales incentives on an ongoing basis. The employer may modify the employer-funded sales incentives based on, for example and without limitation, changes in the costs incurred by the employer while the asset remains unsold or from delaying the employee's relocation. In various aspects, an employer may offer employer-funded sales incentives to all prospective purchasers or a subset of prospective purchasers. Prospective purchasers may be divided into five categories: (1) relocating employees—employees that are being relocated by their employers; (2) non-relocating employees—employees that are not being relocated by their employers; (3) expanded network relocating employees; (4) expanded network non-relocating employees; and (5) members of the general public. As used herein an “expanded network” refers to a network of employers who have agreed to offer employer-funded sales incentives to each other's employees which are different from those offered to members of the general public and may be different from those offered to each employer's own employees. Thus, “expanded network relocating employees” are employees of another company in the expanded network who are being relocated by their respective employers. “Expanded network non-relocating employees” are employees of another company in the expanded network who are not being relocated by their employer.

For example, if both Company A and Company B participate in the closed-seller online marketplace, and are members of an expanded network, Company A may offer an employer-funded sales incentive of $5,000 on a relocating employee's property to other Company A relocating employees, $3,000 to Company A non-relocating employees, $2,000 to Company B relocating employees, $1,500 to Company B non-relocating employees, and $1,000 to the general public.

In various aspects, a prospective purchaser may only be able to see the available employer-funded sales incentives while searching the property listings on the closed-seller online marketplace. In the above example, an Company A non-relocating employee may only be able to view the $3,000 incentive.

In various aspects, an employer-funded sales incentive may be static or it may change dynamically as a function of certain variables selected by the employer. For example, the employer-funded sales incentive may be calculated as a function of, for example, a metric calculated by an independent entity such as the Housing Price Index (calculated by the U.S. Office of Federal Housing Enterprise Oversight), the National Association of Realtor's index, the S&P/Case-Shiller Index, or any other publicly-available, widely-disseminated and reputable index.

In various aspects, the employer-funded sales incentive may also be calculated as a function of options selected by the prospective purchaser. For example, if a prospective purchaser is willing to go to closing within 30 days, a percentage of the monthly expense incurred by the employer while the property remains unsold can be automatically added to the employer-funded sales incentives.

In various aspects the employer-funded sales incentive may also be calculated as a function of options selected by the employer. For example, if the employer is moving several employees out of the same geographic area, the incentive may be automatically increased or decreased for a property when another property owned by an employee of the company from that geographic area is sold by another relocating employee.

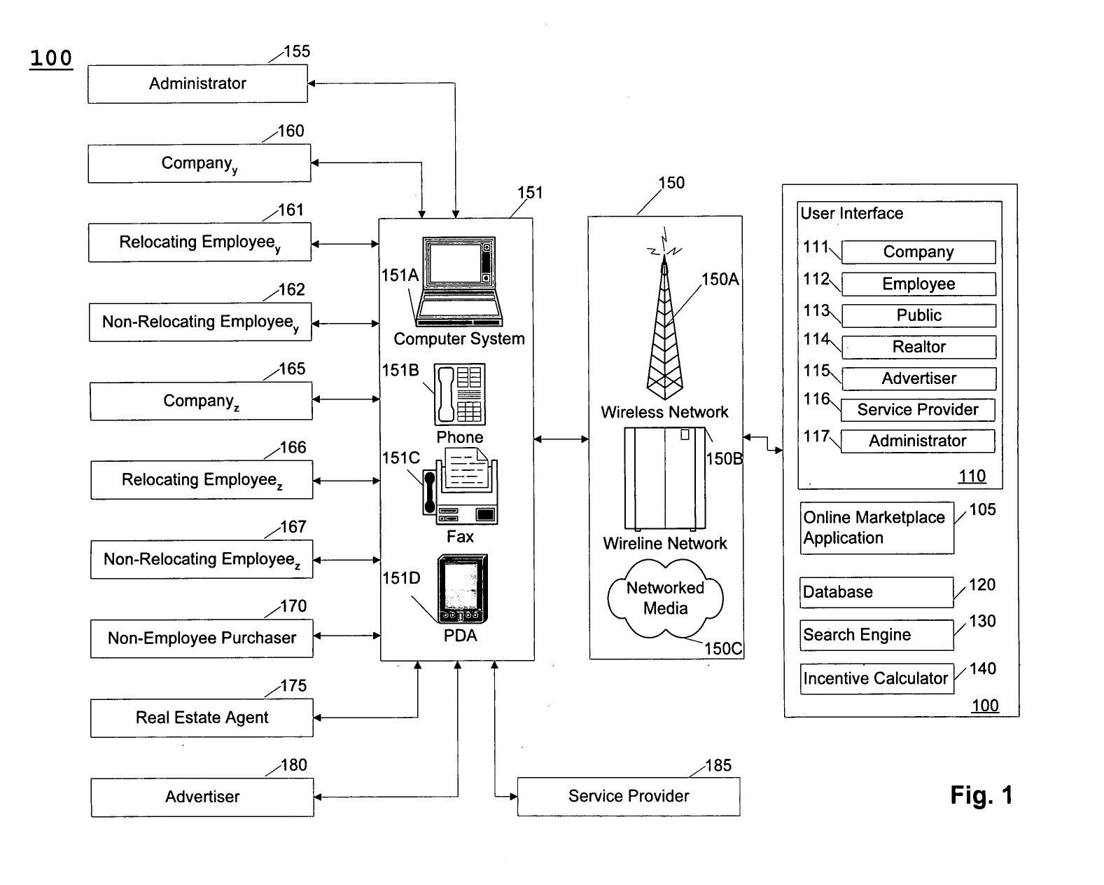

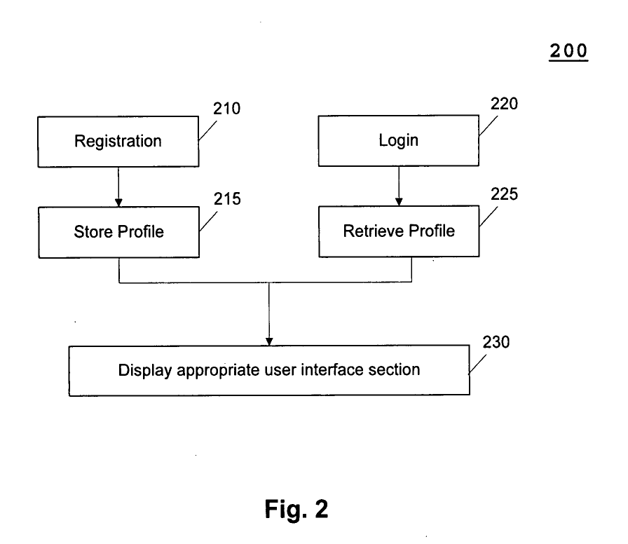

Referring to FIG. 1—a block diagram of an exemplary online marketplace system 100, and FIG. 2—a flowchart illustrating an exemplary operational overview process 200, according to various aspects of the invention, are shown.

In various aspects, online marketplace system 100 may include an online marketplace application 105, a user interface 110, a database 120, a search engine 130, and an incentive calculator 140. In various aspects, online marketplace system 100 may be implemented on, for example, a web-based server or another suitable server or computer system such that it may execute at a Web site which sends out Web pages in response to Hypertext Transfer Protocol (HTTP) or Hypertext Transfer Protocol Secured (HTTPS) requests from remote browsers being used by users (155-185) of system 100.

In various aspects, online marketplace application 105, user interface 110, database 120, search engine 130, and incentive calculator 140 may be, for example, software programs or other applications or devices that execute programs in association with online marketplace system 100. The online marketplace application 105, user interface 110, database 120, search engine 130, and incentive calculator 140 may be programmed in any of a variety of suitable programming languages, such as C++, C, Java, PHP, and/or a variety of other kinds of software programming/scripting languages that may be applied to create instructions in accordance with aspects of the invention.

In various aspects, online marketplace application 105 can be configured to communicate with the parties using system 100 and process communications to and from the parties. Online marketplace application 105 can be configured to provide distinct types of access with a variety of different features to different parties. The parties may include, for example and without limitation, an administrator 155, companies_{y} 160, relocating employees_{y} 161, non-relocating employees_{y} 162, companies_{z} 165, relocating employees_{z} 166, non-relocating employees_{z} 167, non-employee purchasers 170, real estate agents 175, advertisers 180, and service providers 185.

In various aspects, online marketplace application 105 may employ user interface 110 which can be configured to allow each type of party to interact with online marketplace application 105. User interface 105 may display only those features which are available to the party as described below.

Online marketplace application 105 may be operatively associated with database 120. In various aspects, database 120 may be capable of storing a profile for each party comprised of information which is provided by that party or one of the other parties. In addition, database 120 may be capable of storing the property listings and other information included in online marketplace system 100.

In various aspects, online marketplace application 105 may employ a search engine 130 which can be configured to search profiles, property listings, and other information based on search criteria entered into user interface 110, as described below.

In various aspects, online marketplace application 105 may employ an incentive calculator 140 which can be configured to combine incentives offered by various parties to determine a total incentive package, as described below.

At steps 210 and 220, a party may register with online marketplace system 100 or log into online marketplace system 100 through user interface 110. During the registration process, a party will designate its type. The types of parties (or “users”) may include, for example and without limitation, an administrator 155, a company_{y} 160, a relocating employee_{y} 161, a non-relocating employee_{y} 162, a company_{z} 165, a relocating employee_{z} 166, a non-relocating employee_{z} 167, a non-employee purchaser 170, a non-employee purchaser 170, a real estate agent 175, an advertiser 180, and/or a service provider 185.

In various aspects, administrator 155 may be an individual or a legal entity such as, for example, an individual, a corporation, a limited liability company, a limited liability partnership, a cooperative, a partnership, a trust, or a joint venture which operates online marketplace system 100 and performs administrative functions.

In various aspects, company_{y} 160 may be any type of employer such as, for example, an individual, a corporation, a limited liability company, a limited liability partnership, a cooperative, a partnership, or a union which is registered to allow its employees to post property listings on online marketplace system 100. A relocating employee_{y} 161 is an employee of company_{y} 160 who is being relocated by company_{y} 160. A non-relocating employee_{y} 162 is an employee of company_{y} 160 who is not being relocated by company_{y} 160 but may still be given access to system 100.

In various aspects, company_{z} 165 may be any type of employer such as, for example, a sole proprietorship, a corporation, a limited liability company, a limited liability partnership, a cooperative, a partnership, or a union which is registered with online marketplace system 100 and is a member of an expanded network with company_{y} 160. Companies_{z} 165 may include, for example and without limitation, companies which have individual agreements with company_{y} 160, all of the employers registered with online marketplace system 100, or a subset of employers registered with online marketplace system 100. Relocating employee_{z} 166 is an employee of company_{z} 165 who is being relocated by company_{z} 165. A non-relocating employee_{z} 167 is an employee of company_{z} 165 who is not being relocated by company_{z} 165 but may still be given access to system 100.

In various aspects, a subset of employers may be comprised of, for example and without limitation, companies_{z} 165 who signed up for the subset or employers with certain characteristics. The characteristics of the employers in a subset may include, for example and without limitation, employers of a specified size (e.g., 10,000 or more employees), employers with specified revenue (e.g., $10,000,000 or more annual revenues, etc.), employers headquartered in a particular geographic location (e.g., employers based in Virginia), employers with a certain number of employees in a particular geographic area, any combination of these characteristics and the like.

In various aspects, a non-employee purchaser 170 is a member of the general public who is registered with online marketplace system 100.

In various aspects, real estate agent 175 may be, for example and without limitation, an individual, a corporation, a limited liability company, a limited liability partnership, a cooperative, a partnership which is licensed to sell real estate in the geographic area in which a property real estate agent 175 is contracted to purchase or sell is located.

In various aspects, an advertiser 180 is any type of legal entity such as, for example, an individual, a corporation, a limited liability company, a limited liability partnership, a cooperative, a partnership, or a union which advertises on online marketplace system 100.

In various aspects, a service provider 185 is any type of legal entity such as, for example, an individual, a corporation, a limited liability company, a limited liability partnership, a cooperative, a partnership, or a union which is included in a directory of service providers on online marketplace system 100. A service provider 185 may be a company that provides a service related to real estate transactions, such as, for example, real estate appraisers, real estate inspectors, moving companies, contractors, electricians, plumbers, exterminators, insurers, maids, carpet cleaners, landscapers, title insurance companies, and the like who provide services associated with real estate.

In various aspects, when a party designates its type, user interface 110 displays prompts for the party to enter information appropriate to that type.

At step 215, after a party has registered in step 210, online marketplace application 105 stores the information provided during registration in database 120 in a profile. At step 225, if the party was already registered, online marketplace application 105 retrieves the profile for the party logging in to online marketplace system 100 from database 120.

Database 120 may store multiple employer profiles, each of which includes individualized, customized records for each company_{y} 160 and company_{z} 165 including, for example and without limitation, company name, company address, login information, account settings, a list of approved relocating employees_{y} 161, a list of registered non-relocating employees_{y} 162, property listing pricing information, employer-funded sales incentive information, and/or various other types of data.

Database 120 may store multiple user profiles, each of which includes individualized, customized records for each relocating employee_{y} 161, registered non-relocating employee_{y} 162, relocating employee_{z} 166, registered non-relocating employee_{z} 167, and non-employee purchaser 170, including, for example and without limitation, a name, an address, account settings, the employer, relocation approval status, property information, realtor information, and/or various other types of data. Non-employee purchasers 170 are members of the general public who are not affiliated with a participating company.

Database 120 may store multiple property listings, each of which includes individualized, customized records for each property listing including, for example and without limitation, the address of the property, relocating employee_{y} 161, the owner of the property, various features of the property, company_{y} 160 that employs relocating employee_{y} 161, any employer-funded sales incentives, any employee-funded sales incentives, and/or various other types of data.

In various aspects, non-employee purchasers 170 may register as users with online marketplace system 100, but non-employee purchasers 170 are not able to post property listings to online marketplace system 100. In various aspects, non-relocating employees_{y} 162 may be prohibited from listing properties, non-relocating employees_{y} 162 may be allowed to list properties, or non-relocating employees_{y} 162 may be allowed to list properties in limited circumstances. If non-relocating employees_{y} 162 are allowed to list properties, it may be without employer-funded sales incentives or, as a fringe benefit or “perk,” company_{y} 160 may choose to provide an employer-funded sales incentive.

Database 120 may store multiple realtor profiles, each of which includes individualized, customized records for a registered real estate agent 175 including, for example and without limitation, the realtor's name, the realtor's address, account settings, a list of associated clients, licenses, and/or various other types of data. Real estate agents 175 may be able to register with online marketplace system 100 so that their contact information is available from within user interface 110. A real estate agent 175 may also be able to associate property listings with their account in order to monitor clients' property listings.

Database 120 may store multiple advertiser profiles, each of which includes individualized, customized records for each advertiser 180 including, for example and without limitation, the advertiser's name, the advertiser's address, account settings, advertisements to be displayed, promotions and discounts offered, advertisement pricing information, and/or various other types of data. An advertiser 180 may be able to advertise on online marketplace system 100 with or without registering. If an advertiser registers with online marketplace system 100, the advertiser 180 may be able to access additional features, such as, for example, modifying the advertisements or managing discounts and promotions that may be integrated into an incentive package by incentive calculator 140.

Database 120 may store multiple service provider profiles, each of which includes individualized, customized records for each service provider 185 including, for example and without limitation, the service provider's name, the service provider's address, account settings, the type of services provided, promotions and discounts offered, pricing information, and/or various other types of data. Service providers 185 may register with online marketplace system 100 in order to be included in a directory of service providers accessible from user interface 110. This directory would then be searchable by any of the parties using system 100.

At step 230, in association with the registration information provided at step 210 or the profile retrieved in step 220, online marketplace application 105 would determine an appropriate section of user interface 110 to display. The various sections of user interface 110 can each be configured to present the users with different options.

In various aspects, user interface 110 may provide a variety of options for the parties to interact or exchange information. These options may include, for example and without limitation, sending messages; instant messaging; posting articles, research, and/or statistical information; linking to articles, research, and/or statistical information; data input forms; bulletin boards; message boards; discussion rooms; and/or FAQs.

The information exchanged through user interface 110 may include information on topics such as, for example, neighborhood-specific information, school reviews, service provider 185 ratings and reviews, service provider 185 recommendations, advertiser 180 ratings and reviews, advertiser 180 recommendations, real estate agent 175 ratings and reviews, real estate agent 175 recommendations, currency conversions, language translations, processes and procedures for buying and selling real estate in foreign countries, advice for buying and selling real estate in foreign countries, international work visa requirements, and/or the legal requirements of buying and selling real estate in foreign countries.

An administrator section 117 of user interface 110 is displayed to an administrator 155 when they are logged in. Administrator section 117 can be configured to provide the functionality necessary for administrator 155 to perform various activities or transactions including, for example and without limitation, maintenance, system administration, customer service functions, edit any information or selection on online marketplace system 100, and/or any other options available to any other type of party. In addition, administrator section 117 may display information about all registered parties, usage statistics, and/or any other information that any other type of party may view.

In various aspects, an employer section 111 of user interface 110 is displayed to an employer when they are logged in. Employer section 111 can be configured to provide the functionality necessary for company_{y} 160 and company_{z} 165 to perform various activities or transactions including, for example and without limitation, edit its profile, approve employees to post property listings, input or modify employer-funded incentives, monitor its employees' property listings, edit a list of preferred service providers 185, edit featured property listings, edit criteria for property listings to be featured, search for service providers 185, respond to requests for reimbursement, respond to requests for employer-funded sales incentive adjustment requests, manage payments to service providers 185, send documentation necessary for international relocation, communicate with other parties, post or remove information, post or delete links to information, generate reports on any information available to company_{y} 160 or its employees, and generate reports regarding performance metrics related to the past, present, and projected costs and savings for individual properties and designated sets of properties.

In various aspects, company_{y} 160 may allow relocating employees_{y} 161, real estate agents 175, and/or prospective purchasers to request employer-funded sales incentive adjustments. An employee-funded sales incentive adjustment request is a request made by one of the parties for an additional employee-funded sales incentive or a modification of an employee-funded sales incentive. Company_{y} 160 may allow employer-funded sales incentive adjustment requests to be submitted for property listings which, for example and without limitation, have been on the market for a minimum period of time, are in a designated geographic area, have not had an employer-funded sales incentive adjustment request submitted previously, are owned by specific employees, and/or are owned by designated class of employees.

In various aspects, company_{y} 160 may designate preferred service providers 185. A company_{y} 160 may restrict the search results displayed to preferred service providers 185 if it has agreed to cover the cost of a service provided by such preferred services provider 185.

In various aspects, company_{y} 160 may designate featured property listings. A featured property listing is a property listing that will appear to a prospective purchaser when that prospective purchaser logs in to online marketplace system 100. A property may be designated as a featured property listing, for example and without limitation, for all prospective purchasers, prospective purchasers looking for a property within a specified geographic area, relocating employees_{y} 161, non-relocating employees_{y} 162, relocating employees_{z} 166, and/or non-relocating employees_{z} 167.

In various aspects, an employee section 112 of user interface 110 is displayed to a relocating employee_{y} 161, a non-relocating employee_{y} 162, a relocating employee_{z} 166, or a non-relocating employee_{z} 167 when they are logged in. Employee section 112 can be configured to provide the functionality necessary for relocating employee_{y} 161, non-relocating employee_{y} 162, relocating employee_{z} 166 and non-relocating employee_{z} 167, to perform various activities or transactions including, for example and without limitation, edit its profile, search property listings, search for service providers 185, request approval to post a property listing, input or modify employee-funded sales incentives, request an employer-funded sales incentive adjustment, request an employee-funded sales incentive adjustment, respond to an employee-funded sales incentive adjustment request, monitor its property listings, manage payments to service providers 185, request documentation necessary for international relocation, communicate with other parties, coordinate appointments with service providers 185, request quotes from service providers 185, view quotes from service providers 185, select service providers 185, post or remove information, post or delete links to information, generate reports on any activity available to the employee.

In various aspects, online marketplace system 100 can be configured to allow the parties to interact with each other in order to streamline various real estate sales and relocation tasks. For example, relocating employee_{y} 161 may need a painter. Relocating employee_{y} 161 may search for and view a list of painters, select several painters to request quotes from, input the necessary information for a quote, and send the request to all of the painters. When the quotes are received, relocating employee_{y} 161 may view the quotes together and select a painter to hire by utilizing user interface 110. This eliminates the need for relocating employee_{y} 161 to make separate requests to each painter to provide a quote and repeatedly provide the same information with each request. It also allows the painter to view several quotes at the same time in user interface 110.

In various aspects, relocating employee_{y} 161 may also coordinate the scheduling of several service providers 185 in user interface 110. For example, a relocating employee_{y} 161 may need an electrician, a painter, a cleaning service, and a real estate agent 175. Relocating employee_{y} 161 may select an electrician, a painter, a cleaning service, and a real estate agent 175 through user interface 110. Relocating employee_{y} 161 may also request that they communicate with each other directly to schedule their respective tasks. This allows relocating employee_{y} 161 to avoid coordinating these appointments. User interface 110 can be configured to display when each of the service providers 185 are scheduled to perform its task and schedule or reschedule its own appointment. This will allow the electrician, painter, and cleaning service to ensure that any electrical problems are repaired first, repairs to the walls caused by the electrician and painting takes place second, and the property is cleaned last. Real estate agent 175 can also make sure that any appointments with prospective purchasers take place after the painter and cleaning service are scheduled to finish their tasks rather than arrive with a prospective purchaser while the property is in disarray. Online marketplace application 105 can also be configured to automatically alert various parties if the electrician reschedules and the painter and cleaning service need to be rescheduled also.

In various aspects, online marketplace application 105 can also be configured to allow a party to search for and book travel arrangements through user interface 110. For example, relocating employee_{y} 161 may want to take a trip to visit a prospective relocation destination or for the actual move. Company_{y} 160 may designate a carrier as a preferred service provider 185—such as, for example, an airline, a hotel, or a rental car company—that its own employees must use, when possible, to be reimbursed. If company_{y} 160 designates preferred service providers 185, then only those options offered by the preferred service providers 185 may be displayed within the search results.

In various aspects, a public section 113 of user interface 110 is displayed to non-employee purchasers 170 when they are logged in. Public section 113 can be configured to provide the functionality necessary for non-employee purchasers 170 to perform various activities or transactions including, for example and without limitation, edit its profile, search property listings, search for service providers 185, request an employer-funded sales incentive adjustment, request an employee-funded sales incentive adjustment, manage payments to service providers 185, communicate with other parties, coordinate appointments with service providers 185, request quotes from service providers 185, view quotes from service providers 185, select service providers 185, post or remove information, post or delete links to information, generate reports on any activity available to the non-employee purchaser 170.

In various aspects, a realtor section 114 of user interface 110 is displayed to real estate agents 175 when they are logged in. Realtor section 114 can be configured to provide the functionality necessary for real estate agent 175 to perform various activities or transactions including, for example and without limitation, edit its profile, search property listings, search for service providers 185, request approval to post property listings, input or edit employee-funded sales incentives, request an employer-funded sales incentive adjustment, request an employee-funded sales incentive adjustment, respond to an employee-funded sales incentives adjustment requests, monitor designated property listings, manage payments to service providers 185 for specific transactions, request documentation necessary for international relocation, communicate with other parties, coordinate appointments with service providers 185, request quotes from service providers 185, view quotes from service providers 185, select service providers 185, post or remove information, post or delete links to information, generate reports on any activity or information available to real estate agent 175.

In various aspects, when a search is being run by a service provider 185, such as a real estate agent 175, a relocation specialist, or a white glove/concierge service, on behalf of another party, an option to select that party may be available. When service provider 185 selects a specific relocating employee_{y} 161 or non-relocating employee_{y} 162, the search results displayed may be restricted to only the preferred service providers 185 designated by company_{y} 160.

In various aspects, an advertiser section 115 of user interface 110 is displayed to an advertiser 180 when they are logged in. Advertiser section 115 can be configured to provide the functionality necessary for advertisers 180 to perform various activities or transactions including, for example and without limitation, edit its profile, search for service providers 185, request approval to post advertisements, input or edit promotions and discounts, monitor the effectiveness of advertisements, manage payments received from various parties, manage payments to administrator 155 for advertisements, communicate with other parties, coordinate appointments with other service providers 185, view inquiries from various parties, generate reports on any activity or information available to the advertiser 180.

In various aspects, a service provider section 116 of user interface 110 is displayed to a service provider 185 when they are logged in. Service provider section 116 can be configured to provide the functionality necessary for a service provider 185 to perform various activities or transactions including, for example and without limitation, edit its profile, search for other service providers 185, request preferred status, input or edit promotions and discounts, manage payments, communicate with other parties, coordinate appointments with other service providers 185, view inquiries from various parties, search for any type of service provider 185, post or remove information, post or delete links to information, generate reports on any activity or information available the service provider 185.

In various aspects, user interface 110 may also display advertisements tailored to particular parties. The advertisements may be selected in a variety of ways including, for example and without limitation, based on the type of user (155-185) or using micro-targeting techniques.

Still referring to FIG. 1, the parties can communicate within online marketplace system 100 and amongst each other by using a variety of communication access devices 151 that can operate in a variety of communication media 150. Examples of access devices 151 include, without limitation, computer systems 151A (e.g., notebooks), phones 151B (e.g., wireless phones), fax 151C, and personal data assistants (PDAs) 151D. Examples of communication media 150 include, without limitation, wireless networks 150A, wireline networks 150B, and a variety of networked media 150C (e.g., intranets or the global, public Internet).

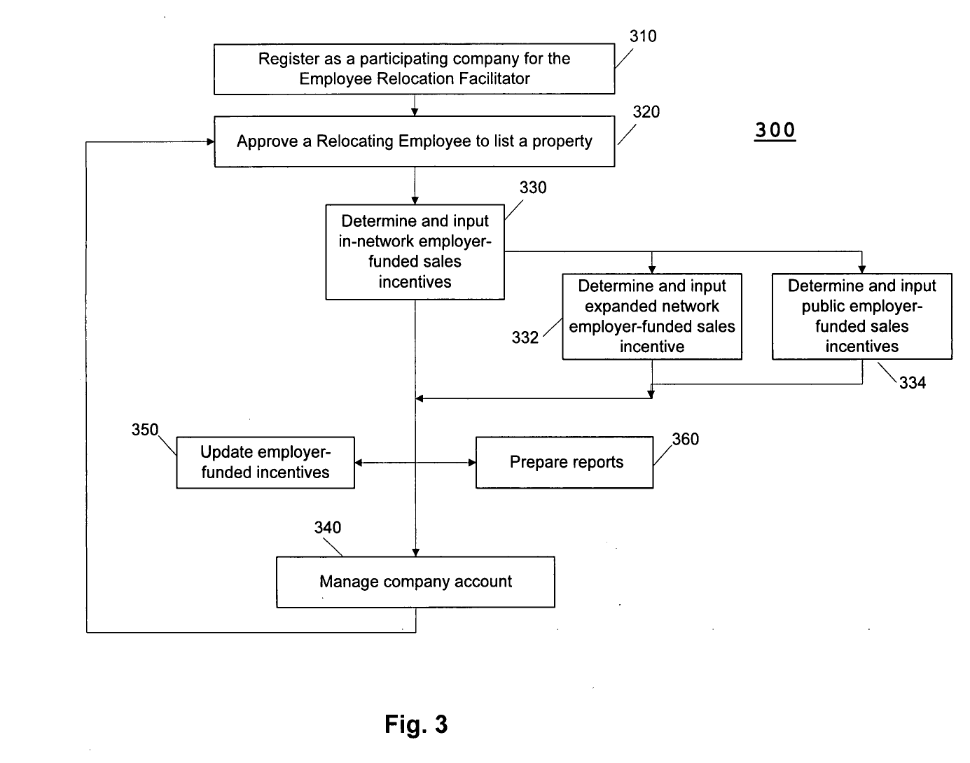

Referring to FIG. 3, a flowchart illustrating an exemplary employer operational process 300, according to various aspects of the invention, is shown. At step 310, company_{y} 160 registers. In various aspects, company_{y} 160 may register by entering information electronically through user interface 110. Company_{y} 160 may also contact administrator 155 using one of the communication media 150 and providing the necessary information to administrator 155 so that administrator 155 may register an account for company_{y} 160. Company_{y} 160 may negotiate and pay the property listing fees during the registration process or at a later time.

After company_{y} 160 is registered with online marketplace system 100, at step 320, company_{y} 160 may begin authorizing property listing accounts for relocating employees_{y} 161, as well as non-relocating employees_{y} 162. A property listing account is an account which allows a relocating employee_{y} 161 or a non-relocating employee_{y} 162 to post a property listing.

A company_{y} 160 may input the authorization in advance of the registration of a property listing account or in response to a request for approval of a property listing account. A property listing account may be authorized in a variety of ways. In various aspects, an e-mail may be sent to company_{y} 160 requesting a reply indicating approval or for a link in the e-mail to be activated to indicate approval. In various aspects, all pending requests for approval may be presented to company_{y} 160 within employer section 111 of user interface 110. In various aspects, company_{y} 160 may also instruct administrator 155 to input authorization for a property listing account.

At step 330, company_{y} 160 may determine what employer-funded sales incentives to offer relocating employees_{y} 161 and non-relocating employees_{y} 162 and inputs data describing those incentives into user interface 110.

At step 332, company_{y} 160 determines what expanded network employer-funded sales incentives to offer and inputs data describing the expanded network employer-funded sales incentives to online marketplace system 100. The expanded network employer-funded sales incentives are offered to employees who work for companies_{z} 165 that are part of company_{y} 160 expanded network.

At step 334, company_{y} 160 determines what public employer-funded sales incentives to offer and inputs data describing the public employer-funded sales incentives to online marketplace application 110. The public employer-funded sales incentives are offered to members of the general public including non-employee purchasers 170. In various aspects, the in-network employer-funded sales incentives, expanded network employer-funded sales incentives, and the public employer-funded sales incentives may be comprised of the same incentives, or each may be comprised of a distinct set of incentives.

At step 340, company_{y} 160 may administer its account using company section 111 of user interface 110 according to the options described above. In various aspects, the employer-funded sales incentives may include, for example and without limitation, one or more fixed sums of money, moving assistance, guarantees on the house, guarantees on the appliances, mortgage assistance, mortgage credits, money towards the closing costs, and/or dynamically-adjusting incentives. A dynamically-adjusting incentive is an employer-funded sales incentive that may be recalculated by incentive calculator 140 based on one or more variables including, for example and without limitation, a housing price index, a prospective purchaser's proposed length of time until closing, the length of time the property has been on the market, the number of other properties in the same geographic area that are receiving employer-funded sales incentives from company_{y} 160, the monthly cost incurred by company_{y} 160 while the property remains unsold, and the like.

In various aspects, company_{y} 160 may opt to receive alerts in the event that, for example and without limitation, an approved property listing is removed from online marketplace system 100, a housing index for a specified geographic area changes by a specified magnitude or percentage, an employer-funded sales incentive adjustment request was made, and/or the like. The alert settings may include options to receive notifications by one or more of e-mail, text message, fax, or telephone call or by having the information displayed in user interface 110.

At step 350, company_{y} 160 may edit an employer-funded sales incentive. In various aspects, user interface 110 can be configured to allow company_{y} 160 to add, remove, or edit employer-funded sales incentives.

At step 360, company_{y} 160 may view information about the property listings it has approved as well as the employer-funded sales incentives it is offering or has offered. In various aspects, user interface 110 can be configured to display information about property listings matching search criteria entered by company_{y} 160 in, for example and without limitation, a list, a table, a chart, or other format. The property listings displayed may include, for example and without limitation, all of the property listings approved by company_{y} 160, a subset of the property listings approved by company_{y} 160, a specific party's property listing, expanded network property listings, or any combination thereof In alternate aspects, various criteria may be used to configure user interface 110 to allow company_{y} 160 to input criteria for the property listings to be included in a report and the format in which they should be displayed. Company_{y} 160 can limit the report to property listings which, for example and without limitation, are in a particular geographic location, have been on the market for a specified length of time, were posted during a specified period of time, have had sales fall through, are under contract, are associated with specific real estate agents 175, have been viewed by a specified number of prospective purchasers, properties offered for a more than a specified price, expanded network property listings, and/or any combination thereof. By viewing information such as this in user interface 110, company_{y} 160 can, for example, evaluate its exposure to a real estate slowdown in a specified geographic area.

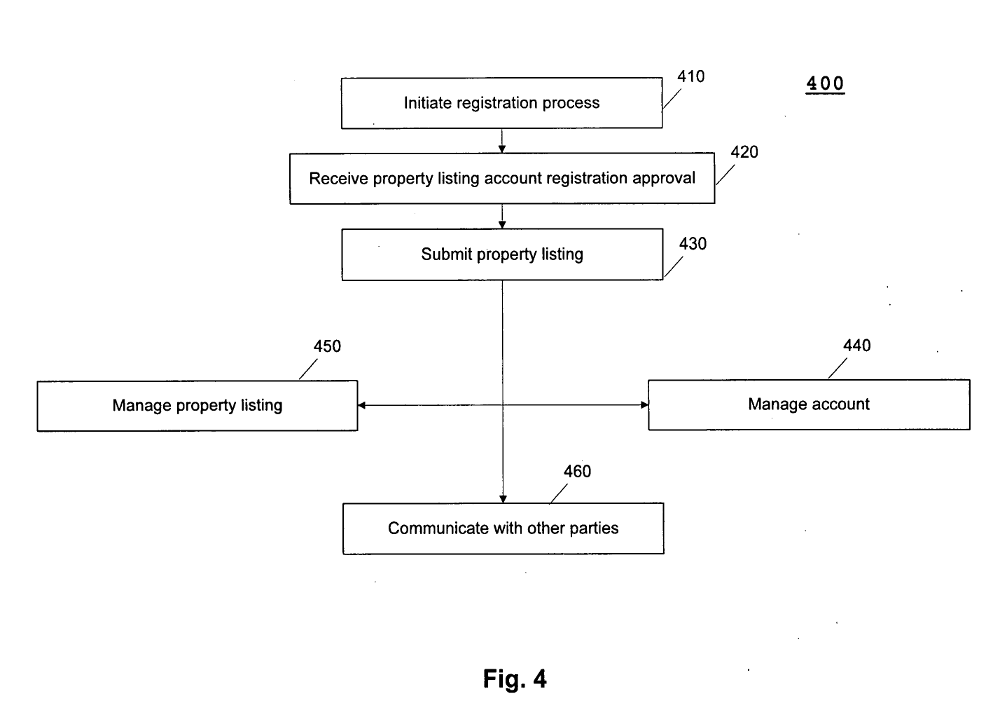

Referring to FIG. 4, a flowchart illustrating an exemplary employee operational process 400, according to various aspects of the invention, is shown. At step 410, a relocating employee_{y} 161 initiates the property listing account registration process. In various aspects, relocating employee_{y} 161 requests approval from company_{y} 160 directly. Company_{y} 160, at step 420, may indicate approval by registering a property listing account for relocating employee_{y} 161 or instructing administrator 155 to register a property listing account for relocating employee_{y} 161. In various aspects, approval to register a property listing account may also be requested from company_{y} 160 through online marketplace system 100. Relocating employee_{y} 161 may select an option presented in user interface 110 for online marketplace application 105 to send a request for approval to company_{y} 160.

At step 430, relocating employee_{y} 161 submits a property listing to online marketplace system 100. After the property listing is submitted, company_{y} 160 determines what employer-funded sales incentives to offer in steps 330, 332, and 334, as described above. In various aspects, the property listing may be submitted by relocating employee_{y} 161, by company_{y} 160 on behalf of relocating employee_{y} 161, or by a real estate agent 175 or service provider 185 on behalf of relocating employee_{y} 161. In addition, company_{y} 160 may bulk upload property listings for several relocating employee_{y} 161.

At step 440, relocating employee_{y} 161 may manage the property listing account using the employee section 112 of user interface 110. User interface 110 can be configured to allow relocating employee_{y} 161 to modify account settings including, for example and without limitation, alert settings or real estate agent 175 designated to represent relocating employee_{y} 161.

At step 450, relocating employee_{y} 161 may manage the property listing. In various aspects, user interface 110 can be configured to allow relocating employee_{y} 161 to, for example and without limitation, add, remove, or modify one or more of a static employee-funded sales incentive, a dynamic employee-funded sales incentive, descriptive information about the property, upload photos, videos, and/or edit the property description.

At step 460, relocating employee_{y} 161 may communicate with other parties through one or more communication media 150. In various aspects, relocating employee_{y} 161 may, for example and without limitation, communicate with company_{y} 160 to request an employer-funded sales incentive adjustment; communicate with other relocating employees_{y} 161, non-relocating employees_{y} 162, relocating employees_{z} 166, non-relocating employees_{z} 167, and/or non-employee purchasers 170, any of whom may be prospective purchasers of the property; communicate with real estate agent 175 regarding representation or the status of potential purchases or sales; communicate with advertisers 180 and/or service providers 185 regarding service offerings, quotes, discounts, or promotions; and/or communicate with a relocation specialist or a white glove/concierge service hired by relocating employee_{y} 161 or company_{y} 160.

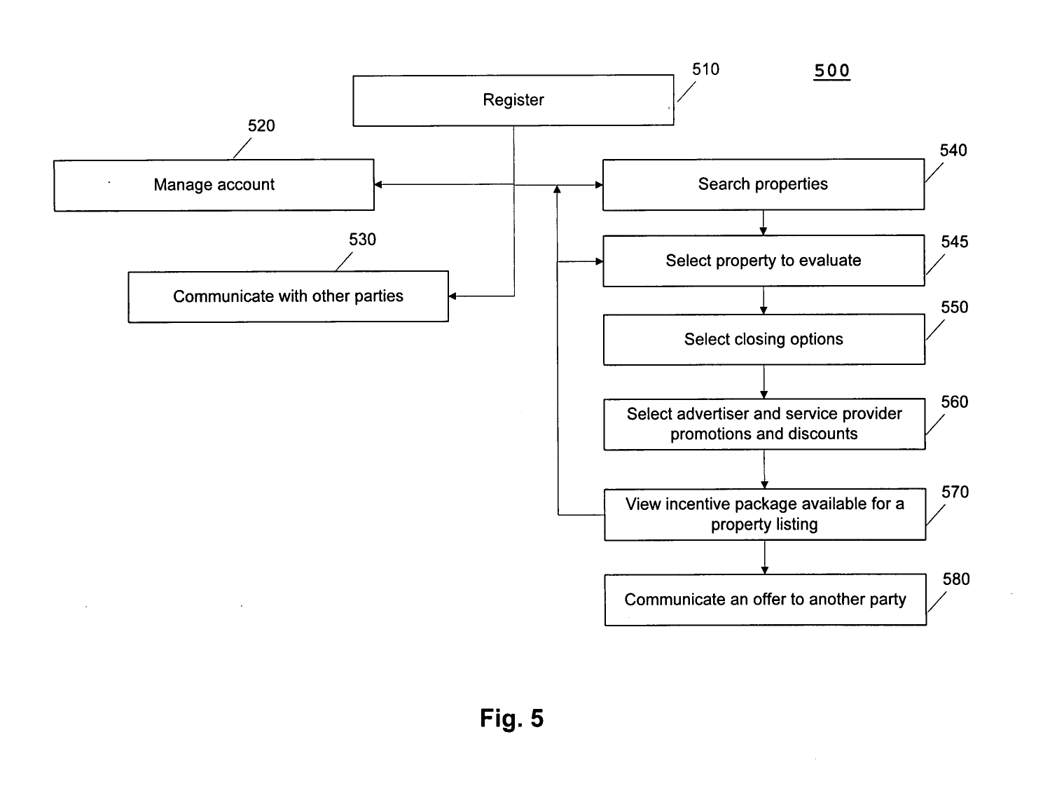

Referring to FIG. 5, a flowchart illustrating an exemplary prospective purchaser operational process 500, according to various aspects of the invention, is shown. In various aspects, a prospective purchaser may be a relocating employee_{y} 161, a non-relocating employee_{y} 162, a relocating employee_{z} 166, a non-relocating employee_{z} 167, or a non-employee purchaser 170.

At step 510, the prospective purchaser registers. In various aspects, relocating employees_{y} 161 who have active property listing accounts, as described above with reference to process 400 (FIG. 4), are not required to register for a separate prospective purchaser account, but may access all of the features available from a prospective purchaser account using their property listing accounts.

At step 520, a prospective purchaser may manage the prospective purchaser account using employee section 112 or public section 113 of user interface 110, as appropriate. In various aspects, user interface 110 can be configured to allow a prospective purchaser to modify the prospective purchaser account settings including, for example and without limitation, alert settings, desired property characteristics (e.g., price range, location, number of bedrooms/bathrooms, etc.), and/or edit the properties on a watch list. A prospective purchaser may choose to be alerted, for example and without limitation, when new properties matching the desired property characteristics are listed, a property listing on the watch list is removed, and/or the incentives offered for properties on the watch list are modified.

At step 530, a prospective purchaser may communicate with other parties through one or more of the communication media 150. In various aspects, a prospective purchaser may, for example and without limitation, communicate with companies_{y} 160 and companies_{z} 165 to request an employer-funded sales incentive adjustment; communicate with relocating employees_{y} 161, non-relocating employees_{y} 162, companies_{z} 165, relocating employees_{z} 166, non-relocating employees_{z} 167, and non-employee purchasers 170; communicate with real estate agent 175 regarding prospective purchases; communicate with advertisers 180 and/or service providers 185 regarding service offerings, quotes, discounts, or promotions.

At step 540, a prospective purchaser may search the property listings. In various aspects, user interface 110 can be configured to allow the prospective purchaser to input search criteria. The search criteria may include, for example and without limitation, a geographic area, a price range, a number of bedrooms, a number of bathrooms, and other standard real estate search criteria which are well known by those skilled in the relevant art(s). The search criteria may also include, for example and without limitation, the name of company providing an incentive for a listing, characteristics of the company offering an incentive for a listing, an incentive type, an incentive value, a dynamic incentive variable, in network status, and/or expanded network status. It can be appreciated that if a prospective purchaser is a relocating employee_{y} 161 or a non-relocating employee_{y} 162, the prospective purchaser may want to view the property listings which afford the prospective purchaser an in-network employer-funded sales incentive or an expanded network employer-funded sales incentive.

In association with the search criteria, search engine 130 searches the property listings in database 120 for matching property listings, online marketplace application 105 retrieves the matching property listings from database 120, and user interface 110 displays the matching property listings. In various aspects, if company_{y} 160 or relocating employee_{y} 161 included any dynamic sales incentives, incentive calculator 140 will recalculate the value of that sales incentive prior to displaying an incentive package including the dynamic sales incentive. In various aspects, after recalculating the value of all dynamic sales incentives associated with a property listing, incentive calculator 140 determines which of the sales incentives are available to the prospective purchaser, and displays a total incentive package comprised of all available sales incentives which match each property listing displayed.

At step 545, the prospective purchaser may select a property to evaluate. User interface 110 can be configured to display the matching property listings in groups with a summary of the property listing information for each property and allow the prospective purchaser to select a property listing to view in greater detail. In various aspects, when the prospective purchaser selects a property listing, user interface 110 displays all of the property listing information available to that prospective purchaser for that property. The information displayed may include the variables which may affect the composition or value of the incentive package and are available to the prospective purchaser for the displayed property. In various aspects, the options may include, for example and without limitation, proposed closing conditions, discounts, and promotions.

At step 550, the prospective purchaser may enter values for the variables that are displayed. In various aspects, incentive calculator 140 may automatically recalculate the incentive package each time the prospective purchaser changes a variable or when the prospective purchaser requests recalculation.

At step 560, the prospective purchaser may select discounts or promotions. In various aspects, user interface 110 is configured to allow the prospective purchaser to select one or more discount or promotion offered by an advertiser 180 or a service provider 185. For example, a title insurance company may offer a 5% discount on the title insurance premium for all properties being sold by Company A relocating employees. If the prospective purchaser selects the option to use that title insurance company, then incentive calculator 140 will automatically recalculate the incentive package to include this discount and user interface 110 will update the displayed incentive package.

At step 570, after the prospective purchaser has finished selecting any desired options in step 550 and promotions and discounts in step 560, user interface 110 displays the total incentive package. In various aspects, the prospective purchaser may return to step 540 to perform a new property listing search, or return to step 550 and select a different property to evaluate.

At step 580, the prospective purchaser selects a property and communicates an offer to another party. In various aspects, the prospective purchaser may communicate the offer to one or more of the owner, a designated real estate agent 175, or company_{y} 160.

The present invention (i.e., system 100, processes 200-500, and the systems and methods for implementing and operating a closed-seller online marketplace for listing employee-owned assets with employer-funded sales incentives described above of the present invention, or any part(s) or function(s) thereof) may be implemented using hardware, software or a combination thereof and may be implemented in one or more computer systems or other processing systems. However, the manipulations performed by the present invention were often referred to in terms, such as “selecting” or “documenting,” which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices.

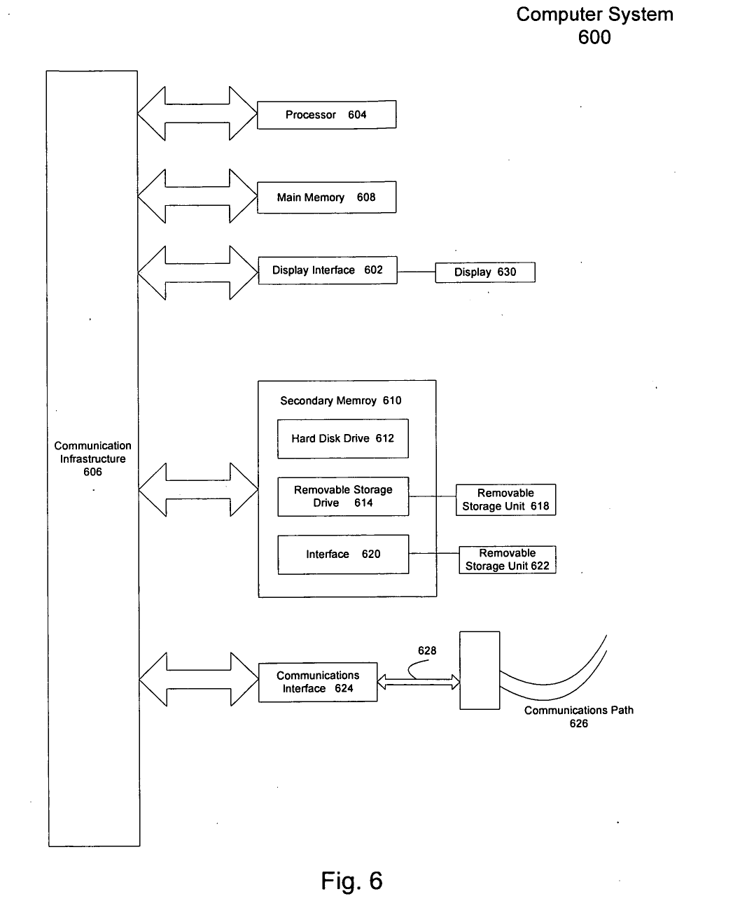

In fact, in one aspect, the invention is directed toward one or more computer systems capable of carrying out the functionality described herein. An example of a computer system 600 is shown in FIG. 6.

Computer system 600 includes one or more processors, such as processor 604. The processor 604 is connected to a communication infrastructure 606 (e.g., a communications bus, cross-over bar, or network). Various software aspects are described in terms of this exemplary computer system. After reading this description, it will become apparent to a person skilled in the relevant art(s) how to implement the invention using other computer systems and/or architectures.

Computer system 600 can include a display interface 602 that forwards graphics, text, and other data from the communication infrastructure 606 (or from a frame buffer not shown) for display on the display unit 630.

Computer system 600 also includes a main memory 608, preferably random access memory (RAM), and may also include a secondary memory 610. The secondary memory 610 may include, for example, a hard disk drive 612 and/or a removable storage drive 614, representing a floppy disk drive, a magnetic tape drive, an optical disk drive, etc. The removable storage drive 614 reads from and/or writes to a removable storage unit 618 in a well known manner. Removable storage unit 618 represents a floppy disk, magnetic tape, optical disk, etc. which is read by and written to by removable storage drive 614. As will be appreciated, the removable storage unit 618 includes a computer usable storage medium having stored therein computer software and/or data.

In alternative aspects, secondary memory 610 may include other similar devices for allowing computer programs or other instructions to be loaded into computer system 600. Such devices may include, for example, a removable storage unit 622 and an interface 620. Examples of such may include a program cartridge and cartridge interface (such as that found in video game devices), a removable memory chip (such as an erasable programmable read only memory (EPROM), or programmable read only memory (PROM)) and associated socket, and other removable storage units 622 and interfaces 620, which allow software and data to be transferred from the removable storage unit 622 to computer system 600.

Computer system 600 may also include a communications interface 624. Communications interface 624 allows software and data to be transferred between computer system 600 and external devices. Examples of communications interface 624 may include a modem, a network interface (such as an Ethernet card), a communications port, a Personal Computer Memory Card International Association (PCMCIA) slot and card, etc. Software and data transferred via communications interface 624 are in the form of signals 628 which may be electronic, electromagnetic, optical or other signals capable of being received by communications interface 624. These signals 628 are provided to communications interface 624 via a communications path (e.g., channel) 626. This channel 626 carries signals 628 and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 614, a hard disk installed in hard disk drive 612, and signals 628. These computer program products provide software to computer system 600. The invention is directed to such computer program products.

Computer programs (also referred to as computer control logic) are stored in main memory 608 and/or secondary memory 610. Computer programs may also be received via communications interface 624. Such computer programs, when executed, enable the computer system 600 to perform the features of the present invention, as discussed herein. In particular, the computer programs, when executed, enable the processor 604 to perform the features of the present invention. Accordingly, such computer programs represent controllers of the computer system 600.

In an aspect where the invention is implemented using software, the software may be stored in a computer program product and loaded into computer system 600 using removable storage drive 614, hard drive 612 or communications interface 624. The control logic (software), when executed by the processor 604, causes the processor 604 to perform the functions of the invention as described herein.

In another aspect, the invention is implemented primarily in hardware using, for example, hardware components such as application specific integrated circuits (ASICs). Implementation of the hardware state machine so as to perform the functions described herein will be apparent to persons skilled in the relevant art(s).

In yet another aspect, the invention is implemented using a combination of both hardware and software.

In general, computer-readable memory media applied in association with aspects of the invention described herein may include any memory medium capable of storing instructions executed by a programmable apparatus. Where applicable, method steps described herein may be embodied or executed as instructions stored on a computer-readable memory medium or memory media. These instructions may be software embodied in various programming languages such as C++, C, Java, PHP, and/or a variety of other kinds of software programming/scripting languages that may be applied to create instructions in accordance with aspects of the invention.

It is to be understood that the figures and descriptions of the invention have been simplified to illustrate elements that are relevant for a clear understanding of the invention, while eliminating, for purposes of clarity, other elements. Those of ordinary skill in the art will recognize, however, that these and other elements may be desirable. However, because such elements are well known in the art, and because they do not facilitate a better understanding of the invention, a discussion of such elements is not provided herein. It should be appreciated that the figures are presented for illustrative purposes and not as construction drawings. Omitted details and modifications or alternative aspects are within the purview of persons of ordinary skill in the art.

It can be appreciated that, in certain aspects of the invention, a single component may be replaced by multiple components, and multiple components may be replaced by a single component, to provide an element or structure or to perform a given function or functions. Except where such substitution would not be operative to practice certain aspects of the invention, such substitution is considered within the scope of the invention.

Variations, modifications, and other implementations of what is described herein will occur to those of ordinary skill in the relevant art(s) without departing from the spirit and scope of the invention as claimed. Accordingly, the invention is to be defined not by the preceding illustrative description but instead by the spirit and scope of the following claims.

The examples presented herein are intended to illustrate potential and specific implementations of the invention. It can be appreciated that the examples are intended primarily for purposes of illustration of the invention for those skilled in the relevant art(s). There may be variations to these diagrams or the operations described herein without departing from the spirit of the invention. For instance, in certain cases, method steps or operations may be performed or executed in differing order, or operations may be added, deleted or modified.

Furthermore, whereas particular aspects of the invention have been described herein for the purpose of illustrating the invention and not for the purpose of limiting the same, it will be appreciated by those of ordinary skill in the art that numerous variations of the details, materials and arrangement of elements, steps, structures, and/or parts may be made within the principle and scope of the invention without departing from the invention as described in the claims.

Further, the purpose of the foregoing Abstract is to enable the U.S. Patent and Trademark Office and the public generally, and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present invention in any way.

What is claimed is:

1. A method for operating an online marketplace for listing employee-owned assets with employer-funded sales incentives, comprising:
(a) providing a user interface to at least one employer and a plurality of employees employed by said at least one employer;
(b) receiving, from one of said plurality of employees, a request to include a property listing in a database, wherein said property belongs to said one of said plurality of employees;
(c) forwarding said request to said at least one employer;
(d) storing said property listing in said database upon receiving approval of said request from said at least one employer;
(e) storing, in said database, a sales incentive received from said at least one employer, said sales incentive affecting the cost of a sale transaction involving said property listing;
(f) allowing, via said user interface, access to a search engine capable of searching said database; and
(g) displaying, via said user interface, said property listing and said sales incentive in response to a query of said database.

2. The method of claim 1, wherein steps (a)-(g) occur over a computer network.

3. The method of claim 2, wherein at least a portion of said computer network is the global, public Internet.

4. The method of claim 1, wherein said at least one employer approves said request because said one of said plurality of employees is in the process of relocating from a first site to a second site in order to remain an employee of said at least one employer.

5. The method of claim 4, wherein said sales incentive is static over the life of said listing being stored in said database.

6. The method of claim 4, wherein said sales incentive received from said at least one employer is at least one of: an amount of money; a moving assistance allowance; an appliance allowance; a mortgage assistance amount; a mortgage credit; and a closing cost allowance.

7. The method of claim 6, wherein said sales incentive is dynamically adjusted over the life of said listing being stored in said database, and wherein said user interface is capable of displaying a current value of said sales incentive.

8. The method of claim 7, wherein said sales incentive amount is dynamically adjusted based upon, at least in part, a publically-available index provided by a third party.

9. The method of claim 4, further comprising:
providing said user interface to a plurality of users, wherein said plurality of users are not employed by said at least one employer.

10. The method of claim 9, further comprising:
storing, in said database, a second sales incentive received from said at least one employer, said second sales incentive affecting the cost of a sale transaction involving said property listing; and
displaying, via said user interface, said property listing and:
said sales incentive in response to said query of said database when said query is received from one of said plurality of employees; and
said second sales incentive in response to said query of said database when said query is from one of said plurality of users.

11. A system for operating an online marketplace for listing employee-owned assets with employer-funded sales incentives, comprising;
a user interface capable of being accessed over a computer network by at least one employer and a plurality of employees employed by said at least one employer;
a database for storing:
at least one property listing, wherein said property belongs to one of said plurality of employees; and
at least one sales incentive, specified by said at least one employer, said sales incentive affecting the cost of a sale transaction involving said property listing; and
a search engine having access to, and capable of searching, said database;
wherein said user interface is further capable of displaying said at least one property listing and said at least one sales incentive in response to a query of said database.

12. The system of claim 11, wherein at least a portion of said computer network is the global, public Internet.

13. A computer program product comprising a computer usable medium having control logic stored therein for causing a computer to facilitate the operations of an online marketplace for listing employee-owned assets with employer-funded sales incentives, said control logic comprising:
first computer readable program code means for causing the computer to provide a user interface to at least one employer and a plurality of employees employed by said at least one employer;
second computer readable program code means for causing the computer to receive, from one of said plurality of employees, a request to include a property listing in a database, wherein said property belongs to said one of said plurality of employees;
third computer readable program code means for causing the computer to forward said request to said at least one employer;
fourth computer readable program code means for causing the computer to store said property listing in said database upon receiving approval of said request from said at least one employer;
fifth computer readable program code means for causing the computer to store, in said database, a sales incentive received from said at least one employer, said sales incentive affecting the cost of a sale transaction involving said property listing;
sixth computer readable program code means for causing the computer to access, via said user interface, a search engine capable of searching said database; and
seventh computer readable program code means for causing the computer to display, via said user interface, said property listing and said sales incentive in response to a query of said database.
